(19) United States
(12) Patent Application Publication
(10) Pub. No.: US 2013/0071170 A1
(43) Pub. Date: Mar. 21, 2013

(54) Two-Part, Touchless Mixing with Collapsible Bellows Container/Connector

(71) Applicants: Richard Jondall Mehus, Richfield, MN (US); Chad Aaron Thompson, Farmington, MN (US); Jeffrey William Plank, Hastings, MN (US); Minyu Li, Oakdale, MN (US); Paul J. Mattia, Prior Lake, MN (US)

(72) Inventors: Richard Jondall Mehus, Richfield, MN (US); Chad Aaron Thompson, Farmington, MN (US); Jeffrey William Plank, Hastings, MN (US); Minyu Li, Oakdale, MN (US); Paul J. Mattia, Prior Lake, MN (US)

(21) Appl. No.: 13/238,452

(22) Filed: Sep. 21, 2011

(51) Int. Cl. A47L 13/30; B67D 7/78

(52) U.S. Cl. 401/139; 222/145.5

(57) ABSTRACT

The present invention is both a method and an apparatus for utilizing a container/connector 10. The container/connector 10 holds a second liquid 110 that is mixed with a first liquid 12a in container 12. Then after mixing to form a use solution, the use solution flows back through the container 10 and out for use by a suitable applicator.

### BACKGROUND OF THE INVENTION

1. Field of the Invention

This invention relates generally to a dispensing system, and more particularly to a dispensing system which utilizes a reversible flow collapsible container.

2. Description of the Prior Art

Floor finishes or polishes often include polymer compositions. The compositions may be aqueous emulsion-based polymer compositions having one or more organic solvents, plasticizers, coating aids, anti-foaming agents, polymer emulsions, metal complexing agents, waxes and the like. When applied to the floor surface and allowed to dry, a protective barrier is formed on the floor.

Currently, various products are used for floor care, such as floor finishes for extending floor substrate use life and providing certain gloss appearances to the surface. Other floor care products include cleaners, strippers and neutralizers. There are multi-part coating systems that are available on the market, such as two-part polyol-isocyanate cross-linkable finishes. U.S. Pat. No. 7,527,861 discloses top coat information, which is related to a multi-part coating system. In addition, Henkel AG and Co., Dusseldorf, Germany, has product QWF4744 which is an OH functional aliphatic water based polyurethane dispersion for highly durable water based, two component coatings.

The present dispensing system provides for an improved dispenser and method for mixing a two-part or two-component system. While the system will be described with respect to floor care products, it is understood that any two-part or two-component use solution may utilize the present invention.

### SUMMARY OF THE INVENTION

In one embodiment, the present invention is a dispensing system that includes a first container for holding a primary liquid product. The first container has a first connector having a first opening that is sealed and a second container for holding a second liquid product. The second container has a second connector adapted and configured to couple with the first connector and be in fluid communication with the first container, wherein when coupled the first opening is unsealed. The second container has a filled position and a dispensed position, wherein moving the second container from the filled position to the dispensed position dispenses the second liquid product into the first container and the first liquid product and second liquid products are mixed to form a use solution. The second container has a second opening that is sealed, the second opening moveable between a sealed position to an unsealed position, wherein the use solution can flow from the first container, through the first opening and then through the second opening.

In another embodiment of the present invention is a method of dispensing a use solution from a first container having a primary liquid product. The method comprises operatively connecting a second container, having a second liquid product, to the first container, dispensing the second liquid product into the first container, thereby forming a use solution. The first container may have one opening, whereby the second container containing a second liquid product is connected to the first container, the second liquid is dispensed into the first container, thereby forming a use solution, the second container is disconnected and removed from the first container, and the use solution can be dispensed through the opening in the first container. The first container may have at least two openings and one of the openings is for connecting a second container, having a second liquid product, to the first container, dispensing the second liquid product into the first container, thereby forming a use solution, and the use solution can be dispensed through the other opening not connecting with the second container. The method also optionally comprises operatively connecting a dispensing member to the second container, whereby the use solution may be dispensed through the second container to the dispensing member.

In another embodiment of the present invention, a dispensing system includes a first container for holding a primary liquid product and a second container for holding a second liquid product, and a fluid passageway for placing the first container in fluid communication with the second container. The first fluid passageway is opened when the second container is operatively connected to the first container, a second fluid passageway in the second container. The second fluid passageway is opened after the second liquid product is mixed with the first liquid product to form a use solution and the use solution is dispensed through the first fluid passageway and then the second fluid passageway.

### BRIEF DESCRIPTION OF THE DRAWINGS

FIG. 1 is a perspective view of the present invention in use;

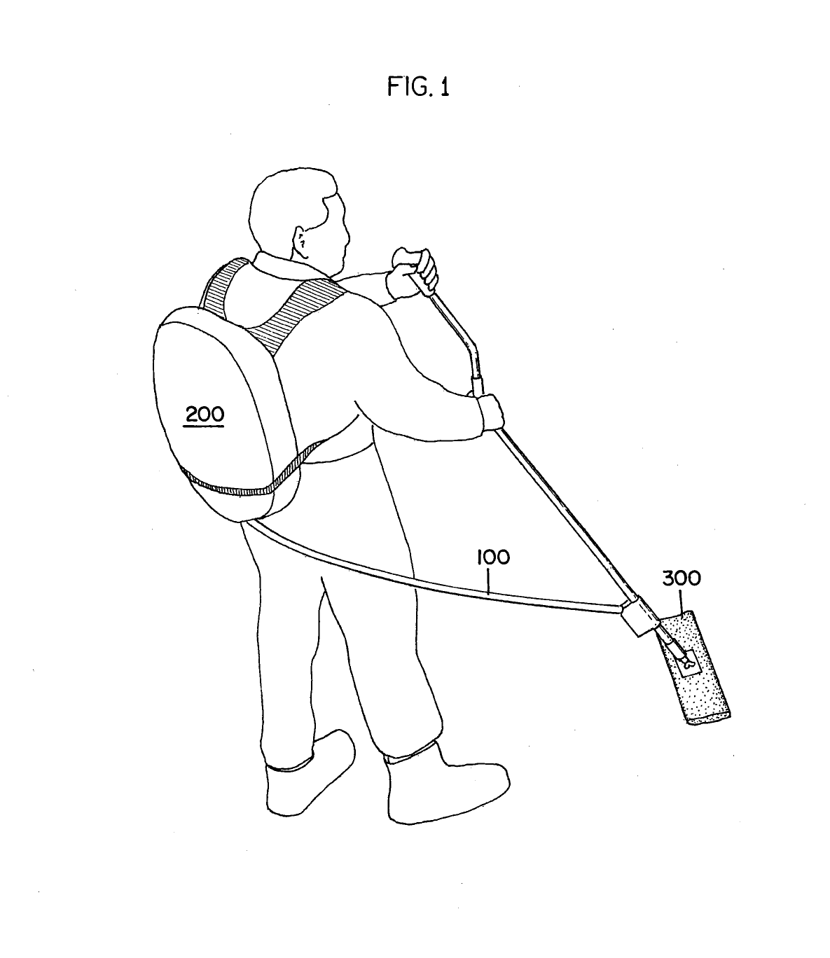

FIG. 2 is an exploded perspective view of the first container of the present invention with the Scholle connector exploded away.

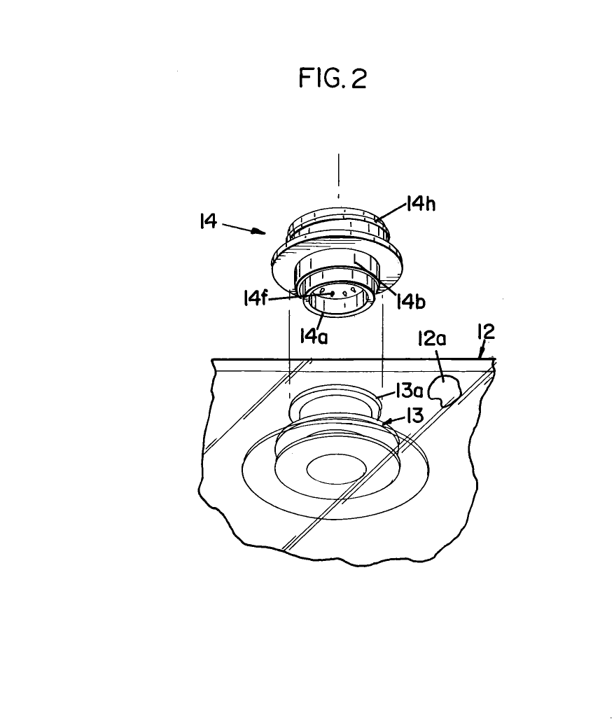

FIG. 3 is an exploded perspective view of the dispensing system of the present invention;

FIG. 4 is an assembled view of a portion of the dispensing system shown in FIG. 3;

FIG. 5 is a cross-sectional view of a portion of the dispensing system shown in FIG. 4 shown in a first position;

FIG. 6 is a cross-sectional view of the dispensing system shown in FIG. 5, in a second position;

FIG. 7 is a cross-sectional view of the dispensing system shown in FIG. 5, in a third position;

FIG. 8 is a cross-sectional view of the dispensing system shown in FIG. 5, in a fourth position, with the cover removed; and

FIG. 9 is a cross-sectional view of the dispensing system shown in FIG. 8, in a fifth position with the outlet fitment attached.

### DETAILED DESCRIPTION OF A PREFERRED EMBODIMENT

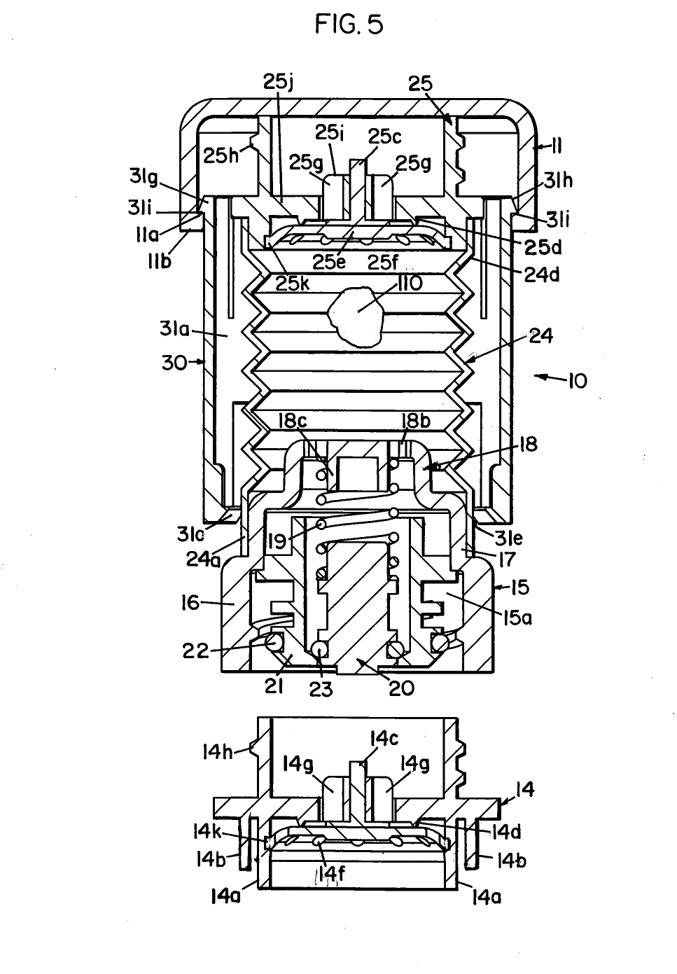

Referring to the drawings, wherein like numerals represent like parts throughout the several views, there is generally shown a container 10. The container 10 will be referred to as a dispensing container. The container 10 includes a removable cover 11. Another container 12 is used to contain a first liquid product 12a. The container 12 will typically be a flexible bag container, but is appreciated that any suitable container may be used. The container 12 has a standard plastic outlet 13 that has a rim 13a. The rim 13a is adapted and configured to receive a suitable connector 14. One suitable connector 14 is a Scholle connector, obtained from Scholle Packaging, Inc., 200 West North Avenue, Northlake, Ill. 60164. The Scholle connector 14 has two spaced, circular walls 14a and 14b that are adapted and configured to have a snap fit over the rim 13a. The connector 14 has a valve stem 14c that is movable along a longitudinal axis. A circular seal 14d provides a seal on a disc 14e to prevent flow of liquid through the connector 14 when in the position shown in FIG. 5. The disc 14e is an elastic deformable member and is positioned in undercuts, or circular slot 14k.

When the valve stem 14c has been moved downward moving the disc 14e downward, the seal 14d is moved away from the disc 14e and liquid is able to flow through openings 14f in the disc 14e and through the cylindrical opening 14g. The connector 14 has a threaded exterior 14h. Also, there is a plurality of openings 14i formed in a cross member 14j. The openings 14i allow for the passage of liquid into the cylindrical opening 14g. The construction thus far described is well known in the art.

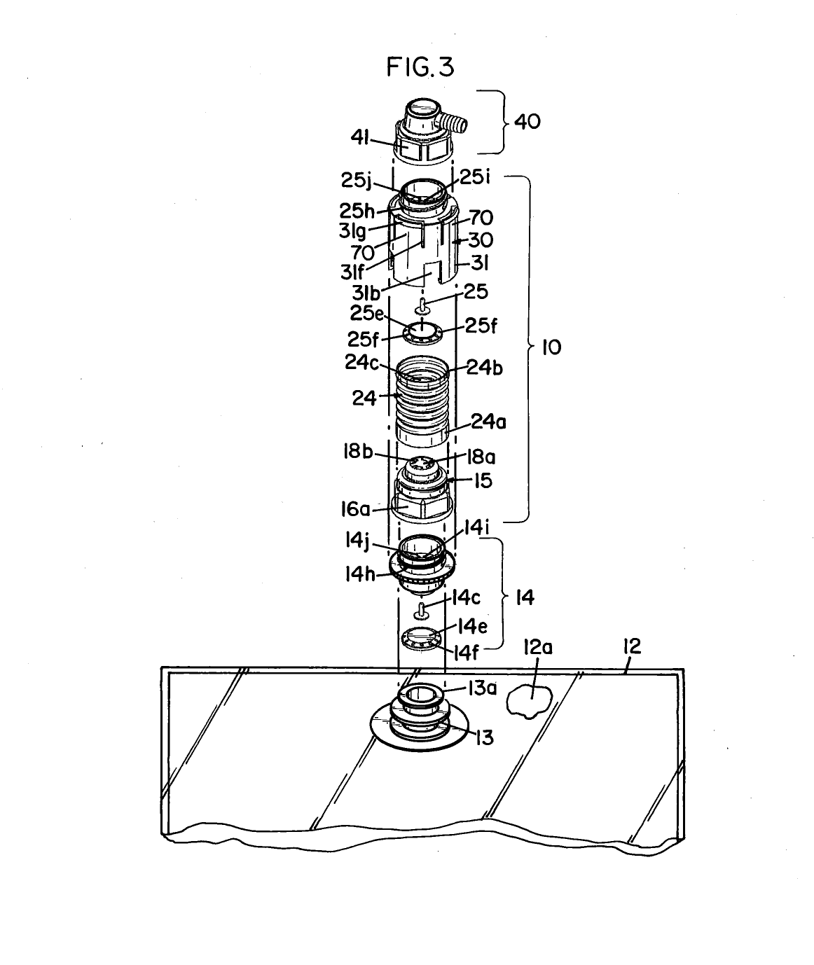

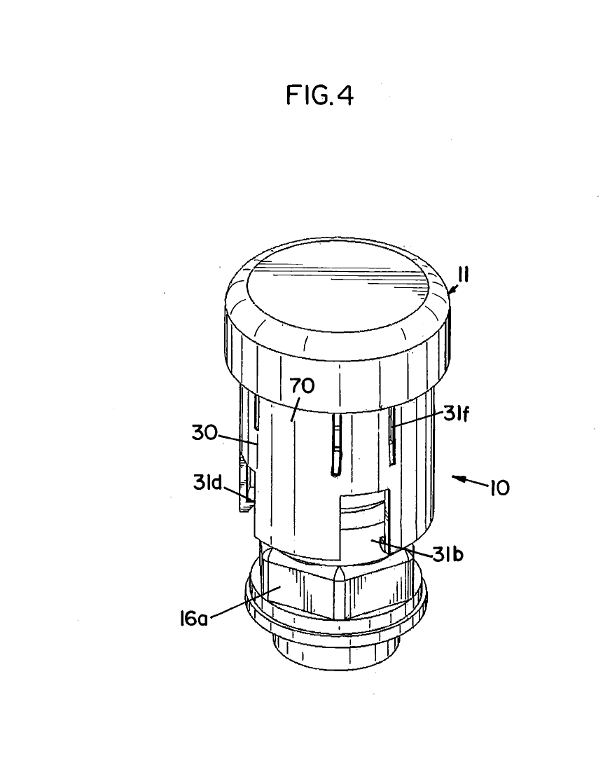

Referring now to FIGS. 3, 4 and 5, the dispensing container 10 is shown in an exploded view in FIG. 3, in an assembled perspective view in FIG. 4 with the addition of the cover 11 and in cross-section in FIG. 5. The dispensing container 10 includes a base member 15. The base member includes an outer wall 16 that is preferably formed as an integral one-piece unit that defines an inner cavity 15a. The outer wall 16 has a lower portion 16a that includes generally planar surfaces that may be utilized to rotate the container 12 to the connector 14. The outer wall 16 forms a first cylindrical section 17 and a second cylindrical section 18. The second cylindrical section 18 has a top 18a with four openings 18b that open into the inner cavity 15a. The top 18a has a downwardly depending circular flange 18c. A spring 19 has a first end positioned around the circular flange 18c and a second end positioned around a check valve 20. The check valve 20 is positioned in a check valve housing 21. A first O-ring 22 provides for a seal between the check valve housing 21 and the outer wall 16. A second O-ring seal 23 provides a seal between the check valve 20 and the check valve housing 21, when the check valve 20 is in a sealed position. The check valve housing 21 is operatively connected to the outer wall 16 by suitable means, such as spin welding.

A collapsible bellows 24 is generally cylindrical in shape and has a plurality of accordion features that allows the bellows to move between an expanded state to a compressed state. The bellows 24 has a first end 24a that is operatively connected to the outer wall 16 by suitable means such as spin welding, ultrasonic bonding or threads with a gasket. A second connector 25 is similar in design and construction to the first connector 14.

The connector 25 has a valve stem 25c that is movable along a longitudinal axis. A circular seal 25d provides a seal on disc 25e to prevent the flow of liquid through the connector 25 when in a closed position. The disc 25e is preferably a deformable elastic member and is positioned in a circular undercut 25k. When a valve stem 25c is moved downward, moving the disc 25e downward, the seal 25d is moved away from the disc 25e and liquid is able to flow through openings 25f in the disc 25e and through the cylindrical openings 25g. The connector 25 has the threaded exterior 25h. Also, there are a plurality of openings 25i formed in a cross member 25j. The openings 25i allow for the passage of liquid out of the cylindrical opening 25g. The second end 24b of the bellows 24 is operatively connected to the connector 25, by suitable means such as spin welding, ultrasonic bonding or threads with a gasket. The cover 11 has a threaded interior to match with the threaded exterior 25h of the connector 25.

The outer housing 30 has an outer wall 31 that forms generally a cylindrical member. The outer wall 31 forms an inner cavity 31a in which the bellows 24 is positioned. The outer wall 31 has four rectangular openings 31b evenly spaced around its outer circumference at its base. The bottom edge of the outer wall 31 includes a lip or inward facing protrusion 31c. The lip 31c has a planar top edge 31d and an angled surface 31e proximate the outer wall 16. Also, four inverted U-shaped sections 70 are defined by openings 31f which are formed in the outer wall 31 to provide for some flexibility, as will be described more fully hereafter. The top circumference of U-shaped sections 70 of the outer wall 31 also have a lip 31g that faces outward and has an angled surface 31h around its side and a planar surface 31i at the bottom of the angled surface 31h.

The outlet fitment or dispensing member 40 is similar to the same outlet fitment that is used in the Phazer® dispenser provided by Ecolab Inc., St. Paul, Minn. and is shown in U.S. Pat. No. 7,794,165, entitled “Floor Finish Application System Including Refill Station”, issued Sep. 14, 2010, which is hereby incorporated by reference.

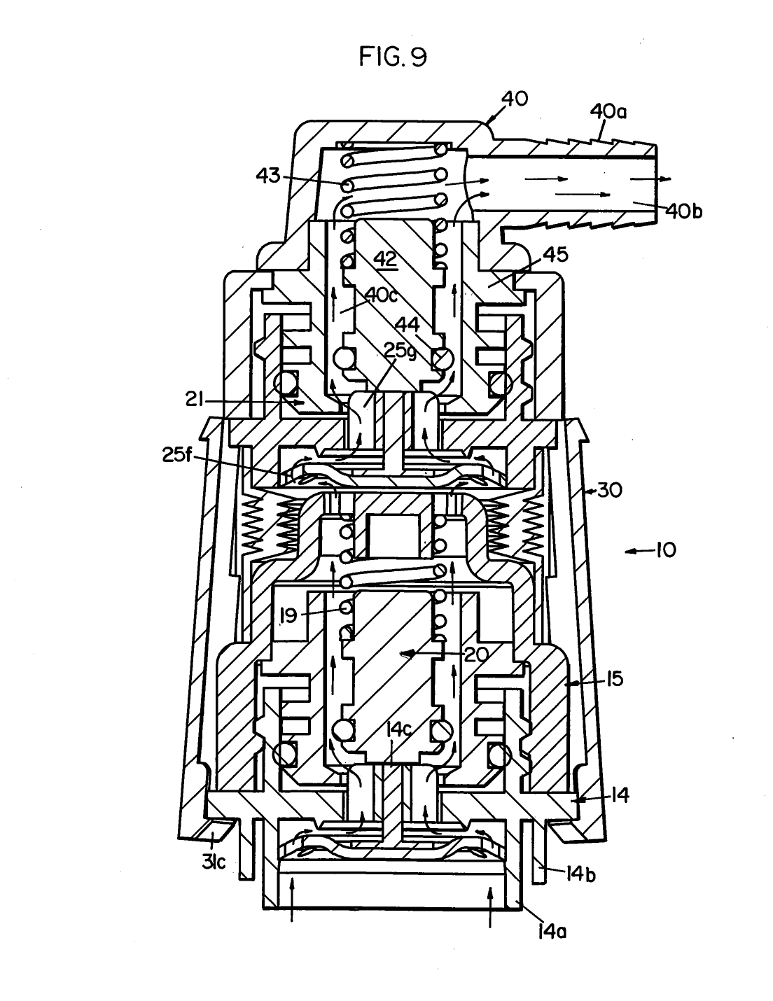

The outlet fitment 40 has a plurality of relatively flat panels 41 around its outer periphery of its housing to aid the user in grasping the fitment while threading the outer fitment 40 onto the connector 25. The outer fitment 40 has a check valve 42 that is positioned with a spring 43 around the check valve 42. FIG. 9 shows the check valve 42 in an up position, wherein liquid is able to flow through the fitment 40, as will be described more fully hereafter. When in a down position, an O-ring seal 44 extends around the check valve 42 and seals the check valve 42 against the check valve housing 45. The fitment 40 has a barbed exterior 40a for attachment to a hose 100. The fitment 40 has a bore 40b which is in fluid communication with the cavity 40c that is formed between the check valve 42 and the check valve housing 45.

In assembling the container 10, the bellows 24 is suitably connected, such as by spin welding, to the connector 25 and the base member 15. The spring 19 and check valve 20 are positioned in the outer wall 16 and the check valve housing 21 is secured to the outer wall 16. The cover 11 is then threaded onto the connector 25. In doing so, the cover 11, that has a lip with a planar flat surface 11a, is threaded unto the threaded exterior 25h of the connector 25. This brings the downwardly depending sidewalls of the cover downward and the bottom edge 11b contacts the angled surface 31h and forces the sides of the connector 25 inward. As the cover 11 continues to be threaded downward, the end then snaps back to the position shown in FIG. 5 and the flat surface 31i abuts the surface 11a and locks the cover 11 in a closed position. This feature is also a part of the lock out mechanism to be described hereafter. The cover 11 now cannot be removed until the liquid 110 is dispensed into the container 10. The interior 24c of the bellows 24 may then be filled with the second liquid product 110. This may be done in any number of suitable ways. One method would be to have a fitment that is similar to the connector 14 attached to the source of the liquid 110. When such a fitment would be attached to the container 10, the second liquid 110 would flow into the cavity between the check valve 20 and the check valve housing 21 and expand the bellows 24 until it is filled. Then as the fitment is removed from the base member 15, the O-ring seal 23 would seal the cavity of the check valve housing 21. The filled container 10 then has the connector 14 threaded into the inner cavity of the outer wall 16.

The container 10 is then ready to subsequently be used by the user. The sequence of operation is now shown in FIGS. 5 through 9. The filled container 10 is shown in FIG. 5.

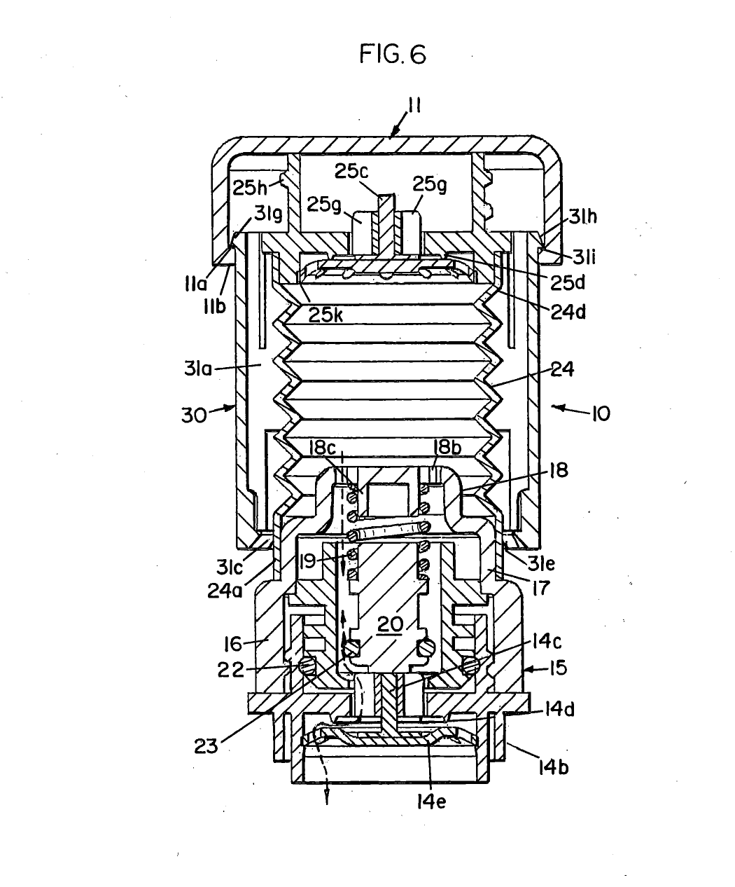

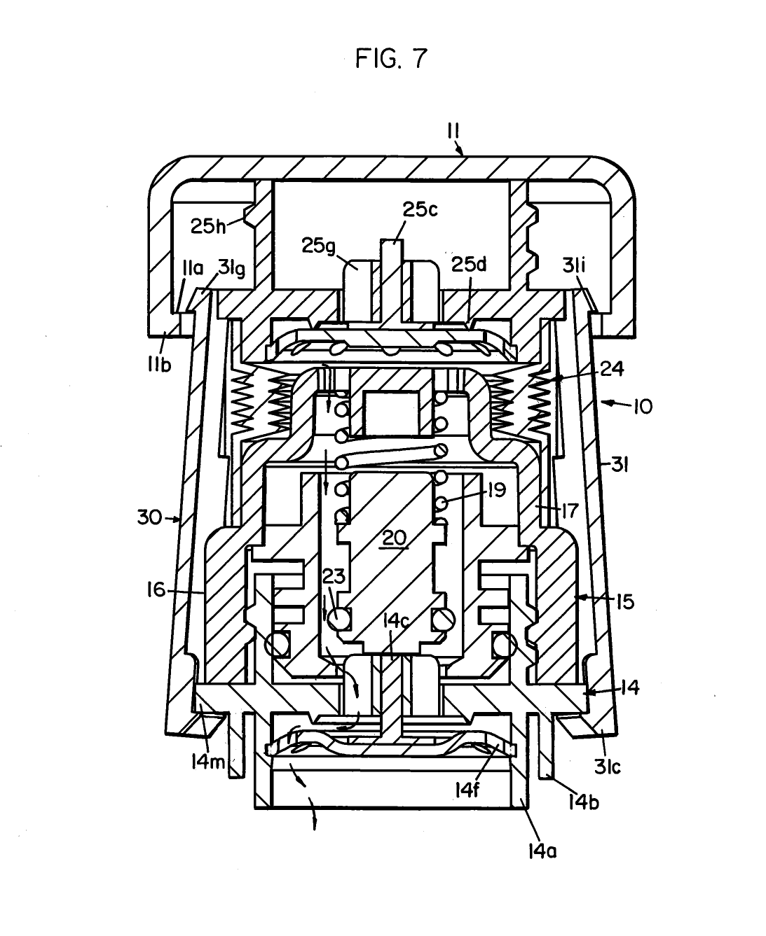

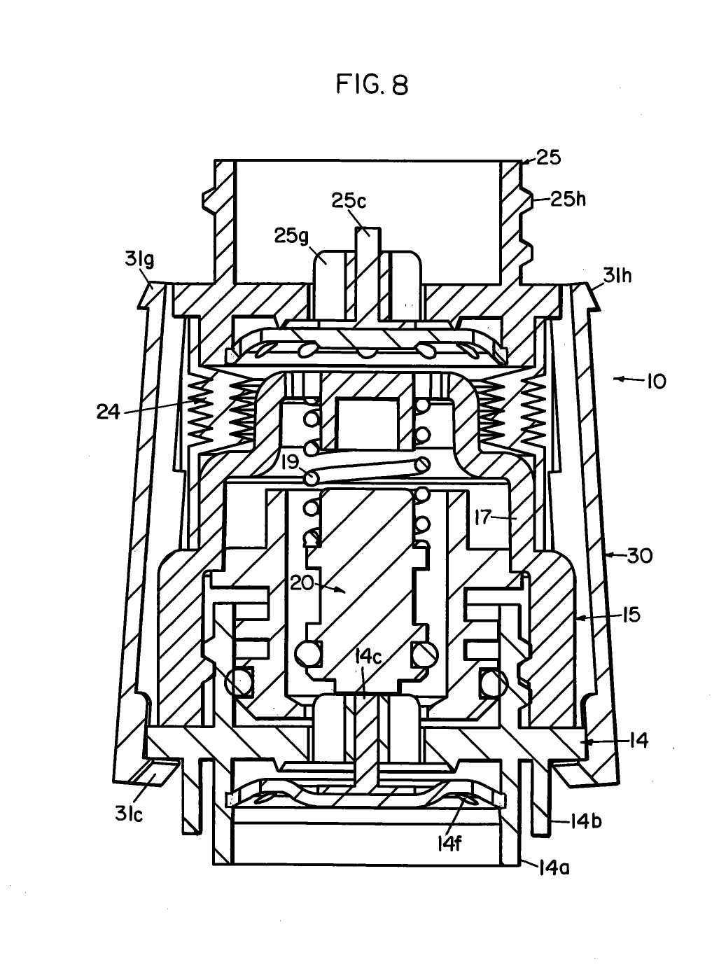

The connector 14 has been operatively connected to the rim 13a of the outlet 13 by snap fitting the connector 14 onto the outlet 13. Then, as the connector 14 is threaded onto the container 10, the valve stem 14c is pushed downward by the check valve 20 and the seal 14d is moved away from the disc 14e and a pathway between the container 10 and the container 12 is formed to place them in fluid communication as shown by the arrows in FIG. 6. In this position, the cover 11 cannot be removed because of the interference fit between the flat surfaces 31i and 11a. This prevents the accidental discharge of the liquid product 110 because the cover 11 cannot be removed until the container 10 is in the position shown in FIG. 7. In the position shown in FIG. 7, the user pushes down on cover 11 and collapses the bellows 24, forcing the liquid 110 into the container 12, as shown by the direction of the arrows in FIG. 7. In getting to this position, the bottom wall 31 of the outer housing 30 is pushed outward (as it contacts the top of base member 15) and lip 31c is hooked on the connector 14 as the lip 31c snaps back inward when the lip 31c clears the connector's 14 outer rim 14m. In doing so, this angles the sections 70 of the outer wall 31 inward and the planar area 11a is no longer engaged by the planar surface 31i and the screw cover 11 may be removed. The inward movement of 31g is designed so that it allows the cover 11 to be removed only after the lip 31c is secured under the rim 14m. In this position, the valve stem 25c is in an up position and O-ring seal 25d prevents flow through the connector 25. FIG. 8 shows the container 10 with the previously discussed cover 11 removed.

Then, in FIG. 9, the outlet fitment, or dispensing member, 40 has been attached. In doing so, the outlet fitment 40 is screwed onto the connector 25. The threading of the outlet fitment 40 onto the connector 25 causes the check valve 42 to push down on the valve stem 25c, thereby allowing liquid to pass from the container 12 around the check valve 42, as shown by the arrows in FIG. 9, out the bore 40b.

After the user pushes down on the cover 11, as shown in FIG. 7, all of the second liquid 110 is dispensed into the container 12 and the two liquids 110 and 12a mix to form a use solution. The use solution is then able to be drawn out through the container 10 and is indicated by the direction of arrows in FIG. 9. Typically, there are approximately 2 ounces of liquid product 110 and 2 gallons of liquid product 12a. However, it is recognized that the volume of liquid product 110 may be easily changed by changing the volume inside of the bellows 24 and related size changes to the other components.

It can therefore be seen, that the container 10, that includes the second liquid, is able to be used both as a container of the second liquid 110 as well as a dispensing member to dispense the second liquid 110 into the container 12. Then, after the outlet fitment 40 is secured to the container 10, the flow is then able to be reversed through the container 10 and out through the outlet fitment 40. The container 10 and 12 combination is placed inside of the backpack 200 and a hose 100, that is connected to the outlet fitment 40 supplies the use solution to an application 300, and the use solution is then dispensed.

As previously discussed, the present invention includes an integrated locking mechanism that does not allow the liquid 110 in container 10 to be dispensed through the dispensing member 40 until the container 12 and container 10 have been connected and the liquid 110 from container 10 fully dispensed into the container 12. Once the liquid 110 is fully dispensed into the container 12, the protective cover 11 is able to be released to allow the container 10 to have the outlet fitment 40 be attached to container 10 and allow for dispensing of the mixed solution containing liquid 12a and 110 for flow through dispensing through the container 10 and out the fitment 40. This is accomplished by not allowing the cover 11 to be removed until after the bellows 24 have been fully compressed. When the bellows 24 have been fully compressed, the liquid 110 is dispensed into the container 12. Once this happens, it is then that the outer wall 31 is inclined sufficiently to allow for the threaded cover 11 to be removed. At the same time, the bottom portion of the outer wall 31 is hooked on the outer rim 14m of connector 14.

The liquid 110 and liquid 12a may both comprise any number of suitable two-part liquids for a two-component system. One suitable liquid for the liquid 12a is a water borne emulsion comprising a polymer or mixture of polymers containing OH functional group. The liquid 110 may be an isocyanate or a mixture of isocyanate compound in a diluted or non-diluted form.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A dispensing system comprising:
(a) a first container for holding a primary liquid product;
(b) the first container having a first connector having a first opening that is sealed;
(c) a second container for holding a second liquid product;
(d) the second container having a second connector adapted and configured to couple with the first connector and be in fluid communication with the first container, wherein when coupled the first opening is unsealed;
(e) the second container having a filled position and a dispensed position, wherein moving the second container from the filled position to the dispensed position dispenses the second liquid product into the first container and the first liquid product and second liquid products are mixed to form a use solution;
(f) the second container having a second opening that is sealed;
(g) the second opening moveable between a sealed position to an unsealed position, wherein the use solution can flow from the first container, through the first opening and then through the second opening.

2. The dispensing system of claim 1, further comprising dispensing member in fluid communication with the second container, wherein operatively connecting the dispensing member to the second container

3. The dispensing system of claim 1, wherein the second container is collapsible.

4. The dispensing system of claim 3, the second container further comprising a bellows in which the second liquid is contained.

5. The dispensing system of claim 1, wherein the primary liquid product is a water borne emulsion comprising a polymer or a mixture of polymers containing OH functional group and the second liquid product is an isocyanate or a mixture of isocyanate compound in a diluted or non-diluted form.

6. The dispensing system of claim 1, further comprising:
(a) the first connector having a first valve stem operatively connected to a first disc;
(b) the first valve stem moving from a first, closed position to a second, open position; and
(c) a first circular seal is positioned proximate the first circular disc in the closed position and away from the first circular disc in the open position.

7. The dispensing system of claim 6, further comprising:
(a) the second container having a second valve stem operatively connected to a second disc;
(b) the second valve stem moving from a second, closed position to a second, open position; and
(c) a second circular seal is positioned proximate the second circular disc in the closed position and away from the second circular disc in the open position.

8. The dispensing system of claim 7, the dispensing member comprising:
(a) a housing;
(b) a dispensing member check valve carried in the housing, whereby when the dispensing member is threaded onto the second container, the dispensing member check valve contacts and moves the second valve stem from its closed position to its open position.

9. The dispensing system of claim 2, further comprising a lock out mechanism operatively connected to the second container, wherein the second liquid product cannot be dispensed through the dispensing member until the second liquid product is dispensed into the first container.

10. The dispensing system of claim 9, the lock out mechanism comprising:
(a) the second container having a housing and a base member;
(b) the housing having a first end, proximate the base member, the first end having an inward facing protrusion;
(c) the housing having a flexible portion having a top edge, the flexible portion operatively connected to the first end of the housing;
(d) wherein movement of the first end over the base member moves the top edge inward, thereby allowing the cover to be removed.

11. A method of dispensing a use solution from a first container having a primary liquid product, the method comprising:
(a) operatively connecting a second container, having a second liquid product, to the first container;
(b) dispensing the second liquid product into the first container, thereby forming a use solution; and
(c) operatively connecting a dispensing member to the second container, whereby the use solution may be dispensed through the second container to the dispensing member.

12. The method of claim 11, further comprising opening a first sealed opening in the first container when the second container is operatively connected to the first container.

13. The method of claim 12, further comprising opening a second sealed opening in the second container when the dispensing member is operatively connected to the second container.

14. The method of claim 12, further comprising the primary liquid product is a water borne emulsion comprising a polymer or a mixture of polymers containing OH functional group and the second liquid product is an isocyanate or a mixture of isocyanate compound in a diluted or non-diluted form.

15. A dispensing system comprising:
(a) a first container for holding a primary liquid product;
(b) a second container for holding a second liquid product;
(c) a fluid passageway for placing the first container in fluid communication with the second container, whereby the first fluid passageway is opened when the second container is operatively connected to the first container;
(d) a second fluid passageway in the second container, whereby the second fluid passageway is opened after the second liquid product is mixed with the first liquid product to form a use solution and the use solution is dispensed through the first fluid passageway and then the second fluid passageway.

16. The dispensing system of claim 15, wherein the primary liquid product is a water borne emulsion comprising a polymer or a mixture of polymers containing OH functional group and the second liquid product is an isocyanate or a mixture of isocyanate compound in a diluted or non-diluted form.
